(19) United States
(12) Patent Application Publication
(10) Pub. No.: US 2003/0139928 A1
(43) Pub. Date: Jul. 24, 2003

(54) System and method for dynamically creating a voice portal in voice XML

(75) Inventors: Yevgeniy Eugene Krupatkin, Cliffside Park, NJ (US); Solomon Fried, Woodmere, NY (US); Sanjeev Kalra, Fairfield, CT (US)

Correspondence Address: Gregory J. Battersby, Esq., GRIMES & BATTERSBY, Post Office Box 1311, Stamford, CT, 06904-1311, US

(73) Assignee: Raven Technology, Inc.

(21) Appl. No.: 10/054,138

(22) Filed: Jan. 22, 2002

(51) Int. Cl. G10L 13/08; G10L 13/00

(52) U.S. Cl. 704/260

(57) ABSTRACT

A system is provided for dynamically converting non-voice enabled documents into voice enabled pages written in VoiceXML without the need for manually coding the document into VoiceXML. The system includes a voice server for accepting the original document, a data server for accepting said HTML document; a run time engine for applying an XSLT translator to such HTML document as well as any requisite data information rendering a VoiceXML version of the original document without the need to manually code such document. It will be appreciated that the system can be used to dynamically convert other non-voice enabled documents.

1. Field of the Invention

The present invention relates generally to a system and method for dynamically creating a voice portal in VoiceXML or VXML and, more particularly, to such a system and method that is able to dynamically create or render voice-enabled documents from written documents in HTML and other languages. It has particular application to dynamically converting a non-voice enabled website to function as voice enabled website.

2. Background of the Invention

The world wide web has dramatically expanded in recent years. Although early web pages were initially static, these pages are now commonly generated on demand from templates, programs, etc. As the web has expanded, so too has web data representation. HTML led into XML which is a general and highly flexible representation of any type of data; and various transformation technologies make it easy to map one XML structure to another or to map XML into other data formats. As the web and the various means of data presentation have advanced in recent years, so also have automated speech recognition (“ASR”) systems or voice recognition systems (“VRS”) as better algorithms and acoustic models are developed and as more computer power can be brought to bear on the task. Examples of such commercially available packages are Speechworks and IBM Via Voice. Today, there are many commercial applications of ASR and VRS in dozens of languages and in areas as diverse as voice portals, finance, banking, telecommunications telecommunications and brokerage. Advances are also being made in speech synthesis or text-to-speech (“TTS”).

As ASR systems have become more popular, there has been a shifting emphasis in web site development from text only sites to voice enabled ones. With the advent of more and more audio and voice based applications for the web, VoiceXML or VXML, a voice extensible markup language, was created. VoiceXML is a web-based markup language for representing human-computer dialogs, just like HTML. While HTML assumes a graphical web browser with display, keyboard and a mouse, VoiceXML assumes a voice browser with audio output (computer-synthesized and/or recorded) and audio input (voice and/or keypad tones). VoiceXML is the foundation for voice application development and delivery and greatly simplifies the difficult task.

VoiceXML began as an outgrowth of research originally conducted by AT&T Research in the mid-1990's. In 1999, representatives of AT&T, Lucent and Motorola created the VoiceXML Forum which began to work on the new language and, by August 1999, VoiceXML 0.9 was created. The specification was circulated to the community for comment and, in March 2000, the first specification for VoiceXML, version 1.0, was published. The Voice XML Forum continued to grow and by that time it included more than 300 members. The forum is active in the conformance testing, education and marketing of VoiceXML and has given control over further language development to the World Wide Web Consortium (W3C). In May 2000, VoiceXML was accepted by W3C who took on the job of the next revision.

VoiceXML potentially expands the power of the web to more than 1 trillion telephones currently in use worldwide because web-based text or data can be delivered via voice and telephones can be used to run searches, invoke bookmarks and otherwise navigate an increasingly voice-enabled Web. The VoiceXML forums suggest four general applications for this new language: information retrieval, electronic commerce, telephony services and unified communications.

There are currently VoiceXML solutions provided by such companies as BeVocal Café, IBM WebSphere Voice Server SDK, Motorola Mobile Application Developer's Kit, Voice Technologies' Nuance V-Builder, Tellme.Studio, Speechworks, Intervoice Bright, and VoiceGenie's VoiceXML Gateway. By and large, however, these solutions all facilitate the creation of a VoiceXML site by assisting the user in programming in VoiceXML. While some independent testing agencies reported that the language is fairly easy to use, it is not uncommon for a programmer to spend weeks in re-coding an HTML site into a VoiceXML site.

A package called VocalPoint uses a combination of specialized tags and style sheets to implement their solution. This, unfortunately, requires that the original source code be changed in order to deliver in a voice medium. This is vastly different from the system of the present invention which does not change the original source and, further, does not require the user to know CSS (Cascading Stylesheets), HTML, VoiceXML and special tags required by VocalPoint.

All of the current VoiceXML developer kits require the user to program or code the new site in the new VoiceXML language. As noted above, while the language is fairly easy to use, coding multiple web site pages into this new language can take weeks or months of time and, as such, represents a time consuming and expensive undertaking for the operator of such a site. In direct contrast, the present invention provides for a system that serves as a rendering tool that uses the Extensible Stylesheet Language Transformations (XSLT) rules stored in a computer to dynamically convert code written in other languages such as HTML to VoiceXML. This differs markedly from the prior art which rely on the independent creation of VoiceXML code.

This offers enormous flexibility in the creation of pages in VoiceXML. The remaining packages require the programmer to learn and know VoiceXML to generate the web page as opposed to simply and dynamically rendering the code from an existing web page using the system of the present invention. It also greatly facilitates any changes to the existing web page since it provides for automatic conversion rather than the need to re-code the data.

### SUMMARY OF THE INVENTION

Against the foregoing background, it is a primary object of the present invention to provide a system and method for dynamically rendering a voice portal.

It is another object of the present invention to provide such a system and method in which the voice portal is created in VoiceXML or VXML.

It is yet another object of the present invention to provide such a system and method in which documents created in HTML and other languages are dynamically converted or translated into VoiceXML.

It is still yet another object of the present invention to provide such a system and method in which the original documents are converted into VoiceXML without the necessity for independently coding it in VoiceXML.

It is but another object of the present invention to provide a tool for generating VoiceXML.

It is still another object of the present invention to provide such a rendering tool that is able to dynamically create VoiceXML code for specific applications and renderings.

It is yet still another object of the present invention to dynamically convert a non-voice enabled website to a voice enabled website.

To the accomplishments of the foregoing objects and advantages, the present invention, in brief summary, comprises a system for dynamically converting documents written in a non-voice enabled language into voice enabled documents written in VoiceXML. The system has a particular application for converting non-voice enabled websites into voice enabled sites without the need to manually re-code the site in VoiceXML. The system makes use of a voice server for accepting the original document; a data server means for accepting the HTML document; means for applying an XSLT translator to such HTML document as well as any requisite data information; and means for rendering a VoiceXML version of the original document without the need to manually code such document in VoiceXML.

It will be appreciated that the system can be used to dynamically convert various forms of non-VoiceXML documents into voice enabled documents including, for example, web pages, word processing documents, e-mail messages and the like.

### BRIEF DESCRIPTION OF THE DRAWING

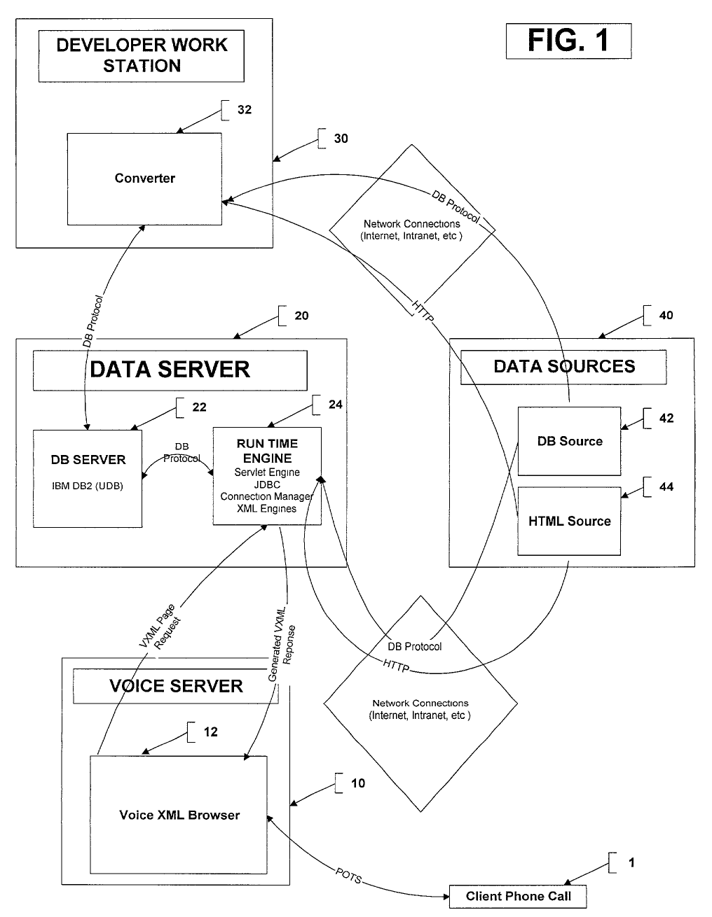

The foregoing and still other objects and advantages of the present invention will be more apparent from the detailed explanation of the preferred embodiments of the invention in connection with the accompanying FIG. 1 which is a flow chart that illustrates the system and method of the present invention.

### DESCRIPTION OF THE PREFERRED EMBODIMENTS

Referring to the drawings and, in particular, FIG. 1 thereof, the present invention is a voice portal that includes a dynamic system for converting a document programmed in another computer language such as, for example, HTML, into VoiceXML without the need for manually re-coding the document into VoiceXML. In this regard, the system includes a voice server 10, a data server 20, a developer work station 30 and data sources 40 for effecting such a conversion.

The voice server 10 includes a VoiceXML browser 12. Voice server 10 is a conventional Windows NT 4.0 server with at least an 800 MHz, Pentium III single processor; at least 1 gigabytes of memory, at least a 4 gigabyte hard drive, a Dialogic CSP (continuous speech processing) analog card; and a T1 Internet connection. Preferably, voice server 10 is a Windows 2000 server having a dual 800 MHz Pentium III processor; at least 2 gigabytes of memory; and at least a 10 gigabyte hard drive.

Voice server 10 receives input as voice over a telephone line through a client call 1 and then passes such input through a VoiceXML browser 12 contained on the voice server 10 that parses the VoiceXML and handles all speech recognition and text to speech operations. VoiceXML browser 12 is conventional software (purchased from, for example, IBM, SpeechWorks or Raven) that is adapted to interface and communicate with the Dialogic card; parse and interpret VoiceXML pages and can run text to speech (“TTS”) and speech recognition engines which are available from companies such as IBM, AT&T, etc. It should be appreciated that the system of the present invention functions independently of the voice server 10 permitting the user to select any platform that is VoiceXML compliant.

Data server or server 20 is a traditional server that runs Windows NT 4.0, has at least an 800 MHz Pentium III single processor; at least 128 megabytes of memory; at least a 4 gigabyte hard disk; and a T1 Internet connection. Preferably, data server 20 runs in Windows 2000 and has a dual 800 MHz Pentium III processor; at least one gigabytes of memory; at least a 10 gigabyte hard drive; and a T1 connection.

Data server 20 includes a database or DB server 22 and a run time engine 24. DB server 22 runs a relational database such as, for example, IBM DB2, Enterprise Edition, v. 7.0 which includes selected pieces of XSLT for use in converting the HTML into VoiceXML. The XSLT is stored in the database along with assorted information on the pages to be converted, data source location, data source type (data source or HTML page), how to ask for a data source, etc. This information is retrieved via the use of unique keys per translation.

While in the preferred embodiment of the present invention, single configurations of the voice server 10 and data server 20 are the most practical, since any machine running a VXML Browser can act as the voice server 10, and any machine capable of running DB2 and Java Servlets can act as the data server 20, it should be appreciated that multiple or alternative configurations of the voice server 10 and data server 20 are anticipated, and may be more appropriate for certain applications.

Run time engine 24 is a set of code written in Java running as a servlet application and incorporating Java Database Connectivity (JDBC) for a database connection as well as TCP/IP Protocols for HTTP sources. JDBC is a known core of libraries, written in Java, that interface to SQL-based database engines. Run time engine 24 provides a consistent interface for communicating with a database and for accessing database metadata (information about the database system vendor, how the data is stored, etc.) Due to the open source nature of the run time engine 24, the platform and operating system that the server runs on is not imposed. The run time engine 24 uses Java servlets 2.1 (which can run on any Java servlet run time engine) and JDBC. The run time engine 24 functions to produce VoiceXML.

When a page is requested, the data server 20 will extract the page information from the data sources 40 which includes a DB source 42 and an HTML source 44. The system can access either or both the DB source 42 and/or the HTML source 44. In this manner, it can obtain any information required from an HTTP or database source (including passing any parameters required by the data source). The result of the translation is a VoiceXML page

The developer work station 30 is a Windows NT workstation having at least 64 megabytes of memory; at least a 60 megabyte hard drive; and at least a 56K Internet connection. Preferably, work station 30 runs in Windows 2000; has at least 128 megabytes of memory; at least 60 megabytes free space on a hard drive, and a LAN or T1 network connection. For testing purposes, it should also include a SoundBlaster (or compatible) sound card, Java Runtime v. 1.3, an IBM Voice server SDK, a microphone and a headset.

Work station 30 includes a converter 32 program which is a Visual Basic tool and targeted at the WinTel 32-bit platform. In the preferred embodiment, the converter program 32 uses a third party tool such as MetaDraw by Benet-Tech Information Systems for creating the mapping or diagram of a current conversation. For additional information on this tool, see www.bennet-tec.com. The software is a Windows tool that can be used to create extensible Stylesheet Language Transformations (XSLT) pursuant to rules that are embedded in the data server 20. It is, essentially, a Visual Basic application with all of the intelligence and rules of XSLT, VoiceXML, HTML and certain database functionalities, e.g., the running of stored procedures, etc. XSLT is a language that is primarily designed for transforming one XML document into another, but more accurately, is a language for transforming the structure of an XML document. It should be appreciated, however, that “MetaDraw” is just one example of the software packages that may be used by the converter program 32. Other examples include “TList 6.5,” also by Bennet-Tec for creating trees and grids; “Ultra Tree,” “UltraGrid,” “Toolbar” and “Outlookbar” by Infragistics; “FTP Control” by XCeedSoft; and “SSLava Toolkit” by Phaos Corporation (www.phaos.com) to perform communications through https to SSL-protected websites.

Converter 32 establishes certain definitions and defines the scripts that will be used in the conversion of non-voice enabled code to voice enabled code. In a preferred embodiment, it is a drag and drop interface for inputting translations into DB server 22. Using converter 32, the user can establish the script used for a particular dialog between the voice server 10 and the client 1. For example, it may identify the specific questions that a user may request, the order in which the questions will be presented, and the information from the data sources 40 that the data server 20 will seek in response to a particular answer.

The interface for the software program converter 30 is divided into two panes. The software 30 includes an object view which is a parsed view of a downloaded site page (HTML) and which is displayed in such a manner that the user can drag and drop components into a working area. This working area is used to connect separate components into a single dialog using an interface of line-connected diagrams and icons (MetaDraw). Along with these components, a user is able to add any missing logic or decisions to fully speech-enable the page.

This conversation is then saved into a database as an XSLT file along with other session information in order to re-open and edit the conversation. VoiceXML and XSLT file fragments are used to create the final XSLT file. These fragments are either stored in the database or coded into the converter 30.

Data sources 40 are external sources that typically constitute the data being converted from a non-voice enabled language to VoiceXML. It can be, for example, a customer's website which is accessible through an Internet connection. It can also be on an intranet. DB source 42 can work with a straight database that is not attached to an HTML site. Similarly, the HTML source 44 can also work directly with a client's website.

In operation, two separate and distinct operations are performed: (1) creating the application using converter 32; and (2) running the application using the data server 20. A user will request a data source from data source 40 (either DB Source 42 or HTML source 44 or both). This source data is then used to create or draw the voice dialog that the user wants as part of their application. This dialog is saved on the server 20 in the DB server 22. The contents of a dialog are the drawing itself, the location and type of data source, and the resulting XSLT file.

The system of the present invention operates in the following manner. The customer, through converter 32, first identifies and reviews the data source 40 to be used in the conversion and establishes the flow or sequence of a particular telephone conversation from a client. Certain sequences are established and responses are created. This is accomplished with drag and drop techniques to establish a suitable flow pattern. Similarly, converter 32 has built into its software, standard XSLT instructions or rules that will be used in the conversion of the non-voice enabled data or site into a VoiceXML document or site. There are a multiplicity of standard XSLT rules for converting non-voice enabled code into VoiceXML code and these rules are keyboarded directly into the converter 32. Once this has been established, the system of the present invention is ready to accept the first call from a client.

The client phone call is initiated from telephone unit 1 and is received by the VoiceXML browser 12 in voice server 10. It will be appreciated that while the requests have to be made by voice, their input source can be virtually any voice source including wireless telephone, desktop microphone and the like. Voice browser 12 then communicates with run time engine 24 which, through converter 32, has established a particular script that is to be used in response to an incoming call. Upon answering the incoming call, the voice browser 12 acknowledges the call, e.g., “Hello, welcome to XYZ” and commences with the predetermined script. Voice server 10 then requests a page from the run time engine 24 in data server 20. A portion of that request is a particular key that is stored in DB server 22 which is unique to a particular page. Run time engine 24 takes this key and makes a request to the DB server 22 for the translation to be applied, the type and location of the data source to apply the translation, etc. It then communicates with the data source 40 and retrieves the document to be translated. The data server 20 uses standard HTTP request and special application parameters. The run time engine 24 uses these parameters to query the DB server 22 which, in turn, provides all the necessary data source locations and parameters so that the run time engine 24 can retrieve the necessary information from the data sources 40 (either DB source 42 or HTML source 44 or both). If the data to be retrieved is a web page, it will collect the HTML that makes up the web page. The server then combines this information with any keys received as part of the original request to obtain the data source information as needed. All the information is then colleted in the run time engine 24 which then applies the XSLT and finally returns the VoiceXML page to the VoiceXML browser.

Run time engine 24 effects the conversion from HTML to VoiceXML by applying the XSLT rules from converter 32 to the HTML source derived from data sources 40. These rules are standard XSLT conversion rules that are manually entered into DB server 22 through converter 32. In practicality, there can be four or five different rules applied per web page. The dynamically re-coded page is then returned by run time engine 24 back to the voice server 10 where it communicates with the client call 1.

The principal difference between the system of the present invention and the prior art is the dynamic manner in which the code of the existing web page is translated into VoiceXML using XSLT to effect the translation literally on the fly rather than relying on the need to hard code the page in VoiceXML. XSLT is a broad conversion tool that is able to convert documents from one language into another by the application of certain rules that are inherent in a particular language. The use of these XSLT tool permits the dynamic conversion or translation of documents of many different formats into VoiceXML documents.

The inherent advantages offered by such a system is that a substantially shorter time is required to deliver the finished VoiceXML coded page. This reduces the resource costs required to effect this task since it requires less sophisticated and, therefore, less expensive programmers. Further, the maintenance cost associated with this product is reduced since it is much more flexible in the conversion processes.

Having thus described the invention with particular reference to the preferred forms thereof, it will be obvious that various changes and modifications can be made therein without departing from the spirit and scope of the present invention as defined by the appended claims.

Wherefore, I claim:

1. A system for converting an original document written in a non-voice enabled language into a voice enabled document, said system including means for communicating with a potential user and means for dynamically converting said original document into a voice-enabled document by the application of an XSLT translator without the need to manually code such voice-enabled document.

2. The system of claim 1, wherein the original document is converted into a VoiceXML document.

3. The system of claim 1, wherein the original document is a web page written in HTML.

4. The system of claim 1, wherein the original document is the product of a database query.

5. The system of claim 1, wherein said means for communicating comprises a VoiceXML browser that parses VoiceXML and handles all speech recognition and text to speech operations.

6. The system of claim 5, wherein said VoiceXML browser is contained on a voice server.

7. The system of claim 6, wherein said voice server is a Windows server.

8. The system of claim 5, where said means for dynamically converting comprises:
a converter for establishing a particular speech sequence and means for entering XSLT rules; and
a run time engine for: receiving a request from said voice browser, obtaining a non-voice enabled document to be converted, applying the XSLT rules from said converter, converting said non-voice enabled document into a voice-enabled document by applying said XSLT rules and outputting the converted document to said voice server.

9. The system of claim 8, further including an external data source containing the original document to be converted.

10. The system of claim 8, wherein said converter is a Windows tool that can create XSLT translations.

11. The system of claim 10, wherein said converter runs on a Windows developer workstation.

12. The system of claim 8, wherein said run time engine is a set of code written in Java running as a servlet application.

13. A system for converting an original document written in a non-voice enabled language into a voice enabled document, said system including:
a voice server for communicating with a potential user;
a converter for establishing a particular speech sequence with a potential user;
means for accessing an external data source containing said original document; and
a run time engine for dynamically converting said original document into a voice-enabled document by the application of an XSLT translator from said converter without the need to manually code such voice-enabled document.

14. The system of claim 13, wherein said run time engine includes:
means for receiving a request from said voice server;
means for obtaining said non-voice enabled document from said external data source;
means for applying XSLT rules from said converter and convert said non-voice enabled document into a voice enabled document; and
means for outputting the converted document to said voice server.

15. A method for dynamically converting a non-voice enabled document to a voice enabled document, said method comprising the steps of:
providing a non-voice enabled document from an external data source;
establishing predetermined XSLT translation rules and a speech sequence and introducing said rules and speech sequence into a data server having a run time engine;
receiving a voice request from a user through a voice server;
communicating the voice request to said run time engine from said voice server;
receiving the appropriate non-voice enabled document from said external source and dynamically converting it into a voice-enabled document by applying the predetermined XSLT translation rules; and
communicating said voice-enabled document to said voice server.

16. The method of claim 15, wherein said non-voice enabled document is a web page written in HTML.
